(19) United States
(12) Patent Application Publication
(10) Pub. No.: US 2001/0030664 A1
(43) Pub. Date: Oct. 18, 2001

(54) Method and apparatus for configuring icon interactivity

(76) Inventors: Leo A. Shulman, Danville, CA (US); Jonathan A. Shiller, Pleasanton, CA (US); Ilya German, San Ramon, CA (US); Eric Schneider, University Heights, OH (US)

Correspondence Address: Himanshu S. Amin, Amin, Eschweiler & Turocy, LLP, 1900 East 9th Street, 24th Floor, National City Center, Cleveland, OH, 44114, US

(21) Appl. No.: 09/725,635

(22) Filed: Nov. 29, 2000

Related U.S. Application Data
(63) Continuation-in-part of application No. 09/640,036, filed on Aug. 16, 2000.
(60) Provisional application No. 60/167,809, filed on Nov. 29, 1999.
(60) Provisional application No. 60/149,118, filed on Aug. 16, 1999.

(51) Int. Cl. G06F 3/14

(52) U.S. Cl. 345/835; 345/810

(57) ABSTRACT

A subscriber device receives notification and it is determined if an icon is to be displayed in response to the received notification. When the icon is to be displayed, the interactivity level or message severity is determined from the context of the received notification and preferences are retrieved from at least one data record corresponding to interactivity level configuration settings. An icon is then generated from the retrieved preferences and it is determined if there is a message associated with the icon from the received notification. If there is no associated message then the icon is displayed. However, when there is an associated message, the message is attached to the generated icon and then displayed.

### RELATED APPLICATIONS

This application claims the benefit of U.S. Provisional Patent Application Ser. No. 60/167,809, which was filed Nov. 29, 1999, entitled METHOD AND APPARATUS FOR CONFIGURING ICON INTERACTIVITY. This application also is a continuation in part of U.S. patent application Ser. No. 09/640,036, which was filed Aug. 16, 2000, entitled SYSTEM AND METHOD FOR NEIGHBORHOOD AUTOMATION and is herein incorporated by reference, which claims the benefit of U.S. Provisional Patent Application Ser. No. 60/149,118, which was filed Aug. 16, 1999, entitled SYSTEM AND METHOD FOR NEIGHBORHOOD AUTOMATION.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This invention generally relates to the field of messaging and notification, and more specifically relates to a method and apparatus for configuring an interactivity level of a graphical icon as a messaging interface.

### BACKGROUND OF THE INVENTION

Graphical icons are ubiquitous to computing devices, particularly to such devices that provide a graphical user interface (GUI). GUI provides a means for a user to interact with the functionality of a given GUI computing device. Icons primarily serve as graphical objects used as an interface to execute a program or provide a visual indication of status in a process. Furthermore, icons can be used as a means for alert or notification to the user when it is determined that a process has encountered a predefined condition. Icons are also used in broadcasting. For instance, a transparent icon of a station identifier or an opaque icon of a weather alert followed by messaging of school closings are common examples of icon usage while watching a television channel. Limitations are that the icon is not dynamic nor can messages delivered be customized while watching television. In essence, the viewer has no control over how such icon and related message information is delivered with the subject matter relating to only television programming or weather related information.

In view of the above, there is an unsolved need to extend the use of icons as a means for notification and communication where the user has control over the amount of interactivity of the icon.

### SUMMARY OF THE INVENTION

The invention provides a robust environment for local and remote home automation processing by using asynchronous publish and subscribe technology to allow devices, macros, users, news, institutions and commerce services to interact in a more meaningful way. The invention utilizes a centralized private network, virtual private network, or secured public network to provide guaranteed message delivery ensuring that critical home automation related events such as security warnings, carbon monoxide detectors, home health monitoring equipment alerts, tornado warnings and the like are delivered to target recipients.

The invention enables users to fully configure instant message delivery in terms of severity, the content of the messages to receive, the persistence with which the messages get delivered, and the location to which they are finally sent. The present invention enables various actions to be performed in response to icon activation. The invention allows users to have messages sent to various locations based on a schedule and bypass any location based on a user login or override. The present invention allows smart routing to determine or derive user location based on environment settings and states. The invention delivers context sensitive advertising to users in response to the event status of devices based on physical events and activities that transpire related to the user household. The present invention can cancel or modify the scheduled notification based upon unknown pending conditions created in the interim.

The invention provides templates of pre-formatted messages to make the message formatting process simple and to thus facilitate improved communication within the neighborhood and among devices, neighbors, and service providers. For messages that require a response, the present invention manages responses by handling all message responses, differentiates and manages successful and failed responses, summarizes all responses back to the message originator, and actively removes messages that are undelivered or unresponsive.

One particular aspect of the present invention relates to selecting configuration parameters associated with a selected notification level. Included in the configuration parameters are an alarm parameter for a user to select audio, tone, mute, and volume settings. A blink rate may be provided to determine how fast an icon such as a SmartIcon will blink. An alert duration may be included to determine how long the SmartIcon is displayed, and a header parameter may be provided to determine what header information is displayed in association with the SmartIcon. Intermittence levels determine what interval for the SmartIcon to intermittently persist, a transparency level determines opaqueness of the SmartIcon, and a size level determines the display size of the SmartIcon. A color level to determine the color of the SmartIcon and a shape level for determining the SmartIcon image/shape for display may also be provided.

Another aspect of the present invention relates to generating an icon. A subscriber device receives notification and it is determined if an icon is to be displayed in response to the received notification. When the icon is to be displayed, the interactivity level or message severity is determined from the context of the received notification and preferences are retrieved from at least one data record corresponding to interactivity level configuration settings. A SmartIcon is then generated from the retrieved preferences and it is determined if there is a message associated with the icon from the received notification. If there is no associated message, then the SmartIcon is displayed. However, when there is an associated message, the message is attached to the generated icon and then displayed.

In yet another aspect of the present invention, an icon is activated upon display. When a displayed icon is not activated then it is determined if the icon has expired. When the icon expires the icon is no longer displayed and the sender of the icon is notified that the recipient icon has expired. When the icon is activated before the icon expires it is determined if the activation is a cancelled action. If the activation is other than a cancelled action it is then determined if a response is requested from the displayed icon. When a response is requested, a template is displayed and a reply is formatted based on submitting the completed template. After a reply is formatted or when a response is not requested it is determined if the message from the icon has an associated action. When there is an associated action then it is determined which action to perform. Actions include updates, navigation, configuration, control functions, transactions, etc.

Another aspect of the present invention relates to an icon for use in a graphical user interface, which includes at least one software object which allows for a user to configure the icon with respect to at least one of the following parameters: volume; blink rate; alert duration; display header; intermittence level; transparency; size; color and shape.

Yet another aspect of the present invention relates to a computer system for providing information to a user. A first computer is operatively coupled to a second computer, the first computer provides the second computer with information to be accessed by a user of the second computer, the second computer includes a graphical user interface to facilitate the user accessing the information. The system also includes an icon for use with the graphical user interface, the icon allows the user to configure the icon with respect to at least three of the following parameters: volume; blink rate; alert duration; display header; intermittence level; transparency; size; color and shape. The parameters vary as a function of the user configuration and the content of the information.

The foregoing and other features of the invention are hereinafter fully described. The following description and the annexed drawings set forth in detail one or more illustrative aspects of the invention, such being indicative, however, of but one or a few of the various ways in which the principles of the invention may be employed.

### BRIEF DESCRIPTION OF THE DRAWINGS

FIG. 1a is an illustration of the logical relationships within a network of local devices, LAS, NNS, NAN, and GNS in accordance with the present invention;

FIG. 1b is an illustration further detailing how NANs are mapped within a network of local devices, LAS, NNS, and GNS in accordance with the present invention;

FIG. 1c is an illustration of LAS components stored in a STB as well as how local devices are connected to the LAS in accordance with the present invention;

FIG. 1d is an illustration of how icons are displayed in the GUI LAS in accordance with the present invention;

FIG. 1e is an illustration detailing the GUI LAS in accordance with the present invention;

FIG. 2a is an illustration of a GUI for selecting an icon interactivity level in accordance with the present invention;

FIG. 2b is a table of settings for each icon interactivity level in accordance with the present invention;

FIG. 3 is an illustration of a GUI for selecting configuration parameters for each icon interactivity level in accordance with the present invention;

FIG. 4a is a flow chart of steps for receiving notification and generating an icon in accordance with the present invention;

FIG. 4b is a flow chart of steps further detailing icon generation in accordance with the present invention;

FIG. 5 is a flow chart of steps for activating an icon in accordance with the present invention; and

FIG. 6 is a flow chart of steps for canceling or modifying a scheduled notification in accordance with the present invention.

### DETAILED DESCRIPTION OF THE INVENTION

The present invention will now be described with reference to the drawings, wherein like reference numerals are used to refer to like elements throughout.

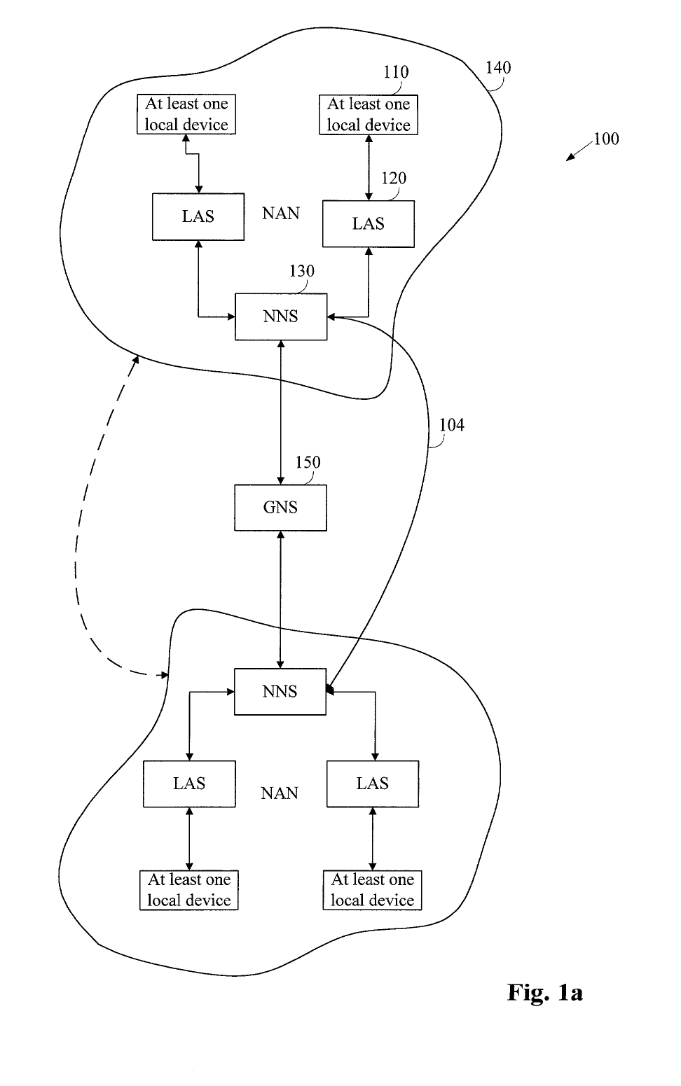

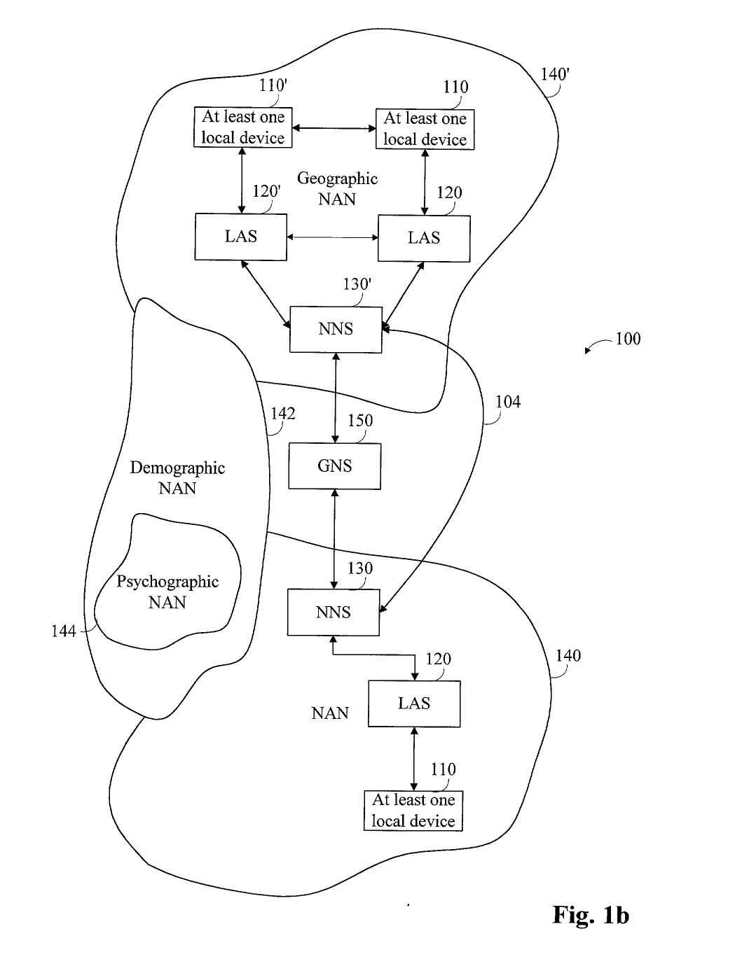

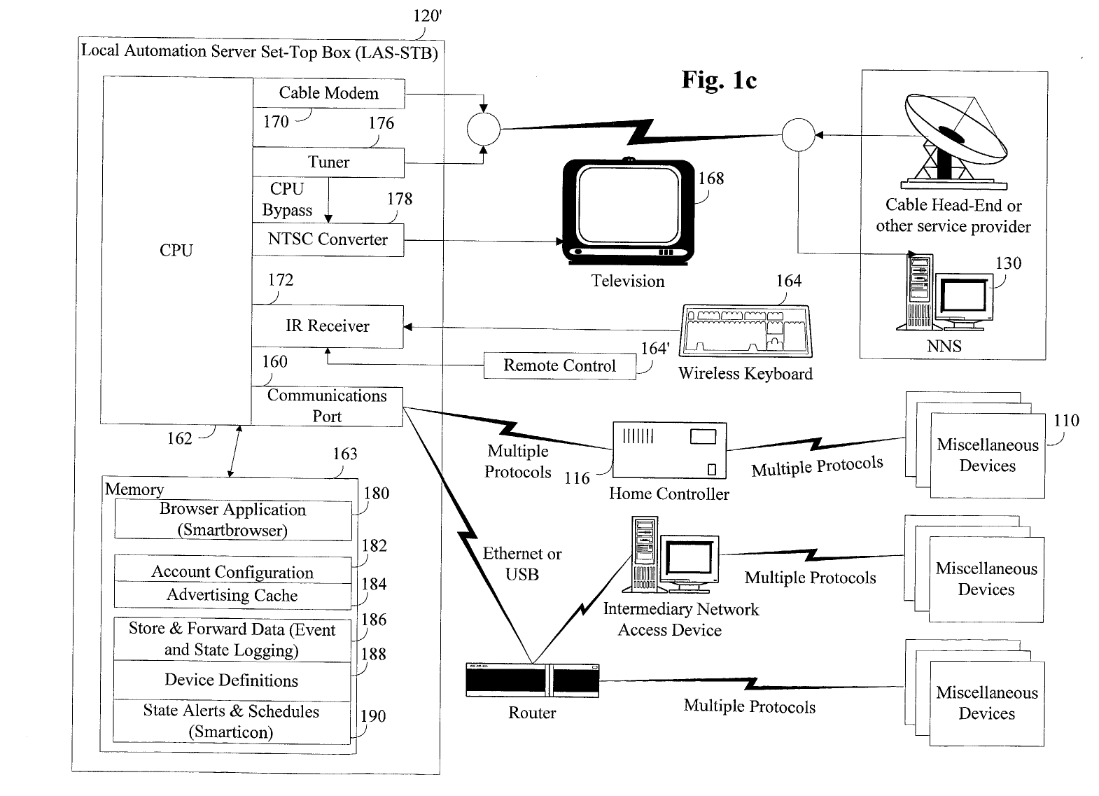

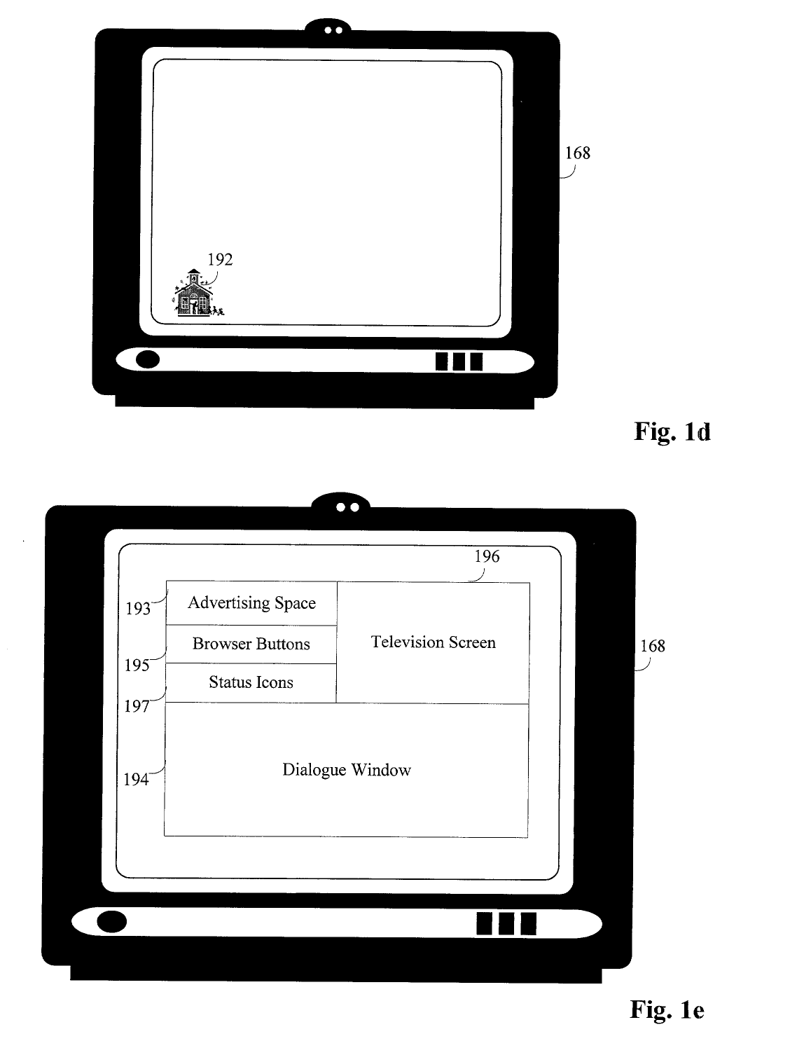

FIGS. 1a-1c introduce a suitable operating and networking environment in accordance with the present invention. FIG. 1a illustrates logical relationships within a network 100 and in accordance with Icon configuration and interactivity that is described in more detail below. The relationships may include local devices 110, Local Automation Servers (LAS) 120, Neighborhood Node Servers (NNS) 130, Neighborhood Automation Namespace (NAN) 140, and a Global Node Server (GNS) 150 or redundant array of GNSs. Each device coupled to the network 100 is referred to as a node, wherein each node may have at least one uniquely addressable namespace. Name space is a set of names in which all names are unique. The NAN 140 is applied with respect to different overlapping zones of a community such as school district, zip code, political subdivision, neighborhood, development, block, side of the street, etc. wherein each zone may be representative of other namespaces having named objects which represent users, processes, events, and devices. The hierarchy and scalability of the NANs 140 remains uniquely addressable from the device 110 level throughout the global infrastructure of the network 100.

The network 100 may employ Internet communications protocols (IP) and/or suite of other protocols 102 or standards such as but not limited to TCP/IP, ATM, LDAP, X10, CEBus, SmartHouse, Medialink, Lonworks, Powerline, IEEE-1394, Home API, HAVI, HomeRF, HomePNA, Universal PnP, or Jini, etc. to enable the local devices 110, which may be configured as clients, to communicate with each other and to servers such as the LAS 120, NNS 130, or GNS 150.

The nodes of the network 100 may further include a modem or transceiver (nol. shown) to establish communication links. The modem may communicate with the network 100 via a line such as a telephone line, POTS, PBX, Centrex, an ISDN line, a coaxial line, a cable television line, a fiber optic line, xDSL modem, a cable-modem, or a computer network line. Alternatively, the modem may wirelessly communicate with the network 100. The network 100 may be provided by an on-line service, an Internet service provider, a local area network (LAN) service, a wide area network (WAN) service, a cable television service, a wireless data service, an intranet, extranet, a satellite service, or the like. However, in many instances server sites may include many computers, perhaps connected by a separate private network or virtual private network. Moreover, the network 100 may include hundreds of thousands of individual networks of computers and devices.

The local devices 110 may be smart devices, internet or network devices, smart card and/or other form ID cards or tags, any sensing device such as but not limited to photoelectric, ultrasonic, capacitive, inductive, level control, thermal, magnetic, optical, or proximity sensing, etc., any device or node having correspondence with a Global Positioning Satellite (GPS), consumer electronics, entertainment components, toys and amusement devices, appliances including vending machines, motorized components, security systems, indoor/outdoor lighting including street lighting, HVAC, sprinklers, hand held devices, palmtop computers, personal digital assistants (PDAs), or substantially any network device not acting as a controlling device. Each local device 110 or node may typically include one or more processors, memories, and input/output devices. Though there may be multiple LASs 120 per residence, household, dwelling, or complex, a single device 110 connected to more than one LAS may be uniquely addressable for each LAS. LAS 120 represent a general class of servers or client/servers on a local level. For instance, Residential Automation servers (RAS), Office Automation Servers (OAS), and Home Automation Servers (HAS), etc., are some examples of a configured LAS 120.

The LAS 120, integrates the users, processes, events, and devices of a home or building, including network accessible apparatus such as but not limited to notebook, laptop, portable computers, desktop PCs, workstations, or larger or smaller computer systems. It is noted that the server network access apparatus may have a variety of forms, including but not limited to, a general purpose computer, a network computer, a set top box (STB), a web-enabled telephone, a portable wireless device, and a game player, for example.

The NNS 130, integrates the users, processes, events, institutions, retailers, and devices of a neighborhood. The NNS 130, which may include servers, are devices that may be running NeighborMation software and communicate on the network 100 as a neighborhood node. NNS servers may physically reside and link either directly or through a LAS to services at different distribution points within a community such as but not limited to a cable headend of a CATV or cable service provider (CSP), a telco switch of a local exchange carrier, a Distributed Control System (DCS) of a gas, electric, or other utility company, an Internet Service Provider (ISP), a Neighborhood Service Provider (NSP), hospitals, banks, institutions including education and non-profit, security service providers for security and alarm monitoring, emergency stations (police, fire, ambulance), post office and other mail delivery services, city hall, municipalities, towns, villages, counties, boroughs, and other (city, state, and federal) agencies, for example.

When communicating between neighborhoods and other communities worldwide, the GNS 150, may be employed as a gateway which may further include corresponding storage servers for global data warehousing, global data mining, global message routing, and a global address book. In an N-tier architecture, the NNS 130 servers may communicate and marshal calls between the LAS servers 120 on a neighborhood node and the GNS 150.

An aspect of the LAS 120, NNS 130, and GNS 150 is that they may range from a single server device that encapsulates the functionality of all servers, to a distributed server farm, that may distribute the functionality of each server into multiple servers. For example, the NNS 130 may be embodied in a distributed server farm 134 (as shown in FIG. 1d) comprising one or more addressing servers, advertising servers, context servers, configuration servers, statistical analysis servers, data warehousing servers, data base servers, e-commerce servers, predictive analysis servers, name servers, and/or routing servers. The LAS 120 and GNS 150 servers may be embodied in a similar manner, with the functionality of each server distributed among multiple servers running in sequence or parallel.

FIG. 1b illustrates a more detailed structure of how NANs may be employed and how NNSs may communicate in the network 100 introduced in FIG. 1a. At least one device 110 has at least one communication link connected to at least one LAS 120 also having at least one communication link connected to at least one NNS 130. A NAN 140 may be defined as having at least one object such as a naming path that represents at least one local device 110. More typically the NAN 140 includes the namespace of a plurality of objects such as all the components of a LAS 120 or further more inclusive of all components of a given NNS 130. A NAN 140 may maintain a namespace that is static or persistent or a namespace that is dynamic or disposable. NANs 140 may take on particular characteristics such as a Geographic NAN (GNAN) 140′, Demographic NAN (DNAN) 142, Psychographic NAN (PNAN) 144, or other NANs with definable characteristics. The GNAN 140′ illustrates more specific relationships that may occur in the network 100. A plurality of LAS (120, 120′) within a given household may be directly linked to each other as well as separately linked to the NNS 130′. In turn, local devices (110, 110′) may be directly linked to each other as well as separately linked to the LAS 120′ allowing more flexibility and robustness with respect to connectivity of nodes in the network.

Furthermore, a plurality of NNSs (130, 130′) within a given neighborhood may be directly linked to each other as well as separately linked to the GNS 150. Though NANs 140 may be mutually exclusive namespaces, it may be common for NANs to overlap or become a subset/superset to one another. FIG. 1b illustrates how a DNAN 142 may overlap with a NAN 140 and GNAN 140′ whereas a PNAN 144 may be a subset of the DNAN 142. NANs may be applied to Special Interest Groups (SIGs), List Groups, Buddy Lists, Internet Gateways, Virtual Neighborhood, Physical or Geographic Neighborhood, e-Commerce Devices, or Home Device Collections, for example.

Enterprise modeling may be applied beyond corporate and business processes to the network 100, to form a neighborhood automation infrastructure (NAI) and in turn a community automation infrastructure (CAI). By extending the enterprise model to resource planning and process modeling that pertain to our everyday lives, such processes may be identified, modeled into events, optimized into steps, encapsulated as device or macro objects, and automated through the local devices 110 in our home, neighborhood, or community. In turn, such nodes and devices may be utilized for messaging, trending, and/or remote configuration and monitoring, for example.

For example, the GNAN or DNAN of a business enterprise may be distributed to divisional and functional levels of an enterprise (e.g., ACME Springs, ACME Widgets, Purchasing Dept. Shipping Dept., etc.). Similar business processes may be found within the same neighborhood where as the processes may differ significantly from neighborhood to neighborhood (consider garbage pickup in Midwest, USA vs. China). However, when local government divisional boundaries are taken into consideration, the commonality of local laws and regulations enforce compliance to standardize community processes. For instance school districts (GNAN) throughout different communities in the U.S. share similar demographics (DNAN) and psychographics (PNAN) within a given neighborhood. Not only are these demographics and psychographics similar, they are well understood and well defined. Process modeling may be applied to such systems for a given school district and act as a school API and/or generic model to be applied to all school districts leaving room for modeling customization in each district as automation is individually applied.

FIG. 1c illustrates one particular aspect of the present invention depicting an STB employed as an LAS 120′. At least one local device 110 that communicates via at least one protocol may be linked to the LAS 120′ either directly or through a home controller, PC, hub, and/or router, for example.

The STB 120′ is the portion of the delivery system that resides in the home of a user. The STB 120′ is usually located above or below the user's television, but it may be placed anywhere in or near the subscriber's home as long as it is within the range of the subscriber's remote control device. In some aspects, the STB 120′ may resemble converter boxes already used by many cable systems. For instance, each STB 120′ may include a variety of error detection, decryption, and coding techniques such as anti-taping encoding. However, it will become apparent from the discussion below that the STB 120′ is able to perform many functions that an ordinary converter boxes cannot perform.

The STB 120′ has a plurality of input and output ports to enable it to communicate with other local and remote devices or nodes. The STB 120′ has a network interface to provide a communication link with at least one local device 110, an input port that receives information from the NNS 130, which in a preferred aspect of the invention may be integrated with a cable headend. In addition, the unit has at least one output port, which provide communications from the STB 120′ to a television and VCR. Also, the STB 120′ may contain a phone jack, which may be used for maintenance, troubleshooting, reprogramming, and additional customer features. STB 120′ may also contain stereo/audio output terminals and a satellite dish input port.

The STB 120′ may receive compressed program and control signals from the cable headend or the NNS 130. After STB 120′ receives the individually compressed program and control signals, the signals are demultiplexed, decompressed, converted to analog signals (if necessary) and either placed in local storage (from which the menu template may be created), executed immediately, or sent directly to the television screen.

The STB 120′ may also store text and graphics transmitted from the cable headend. The text may inform the subscriber about upcoming events, billing and account status, new subscriptions, or other relevant information. The text and graphics may be stored in an appropriate memory location depending on the frequency and the duration of the use of the headend message.

Also, optional upgrades are available to enhance the performance of user's STB 120′. These upgrades may include a cartridge or computer card (not shown) that is inserted into an expansion slot in the STB 120′ or may include a feature offered by the cable headend or NNS 130 to which the user may subscribe. Available upgrades may include online data base services, interactive multi-media services, access to digital radio channels, and other services.

According to a particular aspect of the present invention, available converter boxes such as those manufactured by General Instruments or Scientific Atlanta, may be modified and upgraded to perform the functions of LAS 120 as a STB 120′. The preferred upgrade is a circuit card with a microprocessor, which is electronically connected to or inserted into the converter box. Other upgrades may include real-time downloading of new LAS 120 component software from the NNS 130.

A communications port 160 is coupled to the CPU 162 and is configured to provide communication with other local devices 110. A RF video signal input port (not shown) connects to a TV tuner 176, which extracts the video signal from the RF carrier. The video signal output from the tuner 176 is fed into a video decryption unit such as a NTSC or PAL converter 178 which carries out any decryption necessary to convert the video signal into standard format. The video signal out of a video output port (not shown) and then to a standard television 168 for display. A remote control port 164 is coupled to the CPU 162 and is configured to receive remote input such as from the remote control 168 or from a front panel (not shown) on the STB 120′. Preferably, the remote port 164 comprises an infrared receiver for receiving infrared signals from the remote control 168. A modem 170 is coupled to the CPU 162 and is configured to provide communication between the STB 120′ and the NNS 130 at a cable headend.

The STB 120′ further includes memory 163 coupled to CPU 162. Within memory 163, operating system (OS) such as Windows CE, Linux, or other OS is used as a platform to execute applications. Further included in memory 163 are LAS 120 software components including a browser application 180 (shown in FIG. 1g), account configuration 182, LAS advertising cache 184, store and forward data for event and state logging also known as the LAS logging cache 186, device definitions 188, and state alerts and schedules 190.

FIG. 1d illustrates a configurable digital image that is displayed at time of message delivery to the LAS 120. The image is referred to as a SmartIcon 192 and is a real time alert architecture that non-obtrusively notifies television viewers and PC users when there is a message or dialogue available for review. The message or dialogue can represent events ranging in importance and interest to the user. Events may include critical messages such as fire, severe weather warnings, or carbon monoxide detection; home automation related alerts such as information about HVAC, lighting, physical security, etc.; national and local breaking news events such as election results, sports scores etc.; community breaking news such as school closings, power outages, etc; community content such as school or church news, bake sale or block party announcements, etc.; neighborhood requests such as a search for a fourth for golf, a request from a neighbor for a baking ingredient, a search for a baby sitter, etc.

An aspect of the SmartIcon 192 can be similar to modern weather alert warnings or station identification icons, which are generally displayed in a corner of the television screen. The icons 192 are generally solid or opaque. The SmartIcon 192 can also act as a line of text similar to school closings or severe weather warning commonly seen on television. The occurrence of the icon 192 with respect to message severity is fully configurable. Network users can pre-determine the severity of the messages they wish to receive. For example, some users may wish to receive tornado warnings, but have no interest in community events. The content of the icons received is fully configurable as well. Users subscribe to interest groups such as any combination of the DNAN 142 or PNAN 144. For example, users may wish to receive sports related messages and requests, but not cooking or gardening. The display type (e.g., persistence, color, size) of the icons received is fully configurable. Network users will be able to choose how long the icon 192 is displayed without acknowledgement before it disappears, whether it flashes or not, its size and color, opaque and/or filled, etc.

FIG. 1e illustrates how the GUI for the browser 180 described above in FIG. 1c is divided into several windows or frames. Users can launch the LAS graphical user interface (GUI) referred to as HomeView 180 with via an input device such as a mouse or keyboard164. The browser then displays the information that the icon 192 represents.

A standard set of internet browser buttons plus some additional HomeView buttons 195 that may include buttons to initiate a search, configure an account 182, configure user preferences, launch E-Mail, World Wide Web, Navigation (back, forward, etc), Undo, Send, Exit, etc. The dialogue window 194 is where user interaction and communication takes place. Features that transact in this window can include entry of search criteria and results display; account and preference configuration 182; device configuration 188, diagnostics, history and detailed monitoring; SmartIcon 192 message display and reply; SmartIcon message creation and sending; community chat, etc. The television screen section 196 is where users continue watching their television programming (TV, cable, VCR, DVD, etc.) and can switch channel or devices (e.g., TV to VCR) while the HomeView is active. The status icon section 197 displays icons 192 that convey the status of various systems and components of the network. The color of the icon indicates clear (green), warning (yellow), and emergency (red). The icons 192 represent the home environment (primarily HVAC), home security, home appliances, neighborhood watch, weather, etc. Clicking on these icons provides detailed status information in the Dialogue window 194.

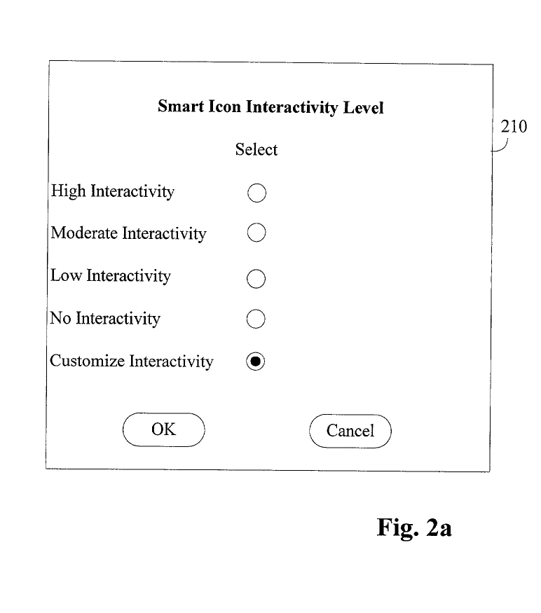

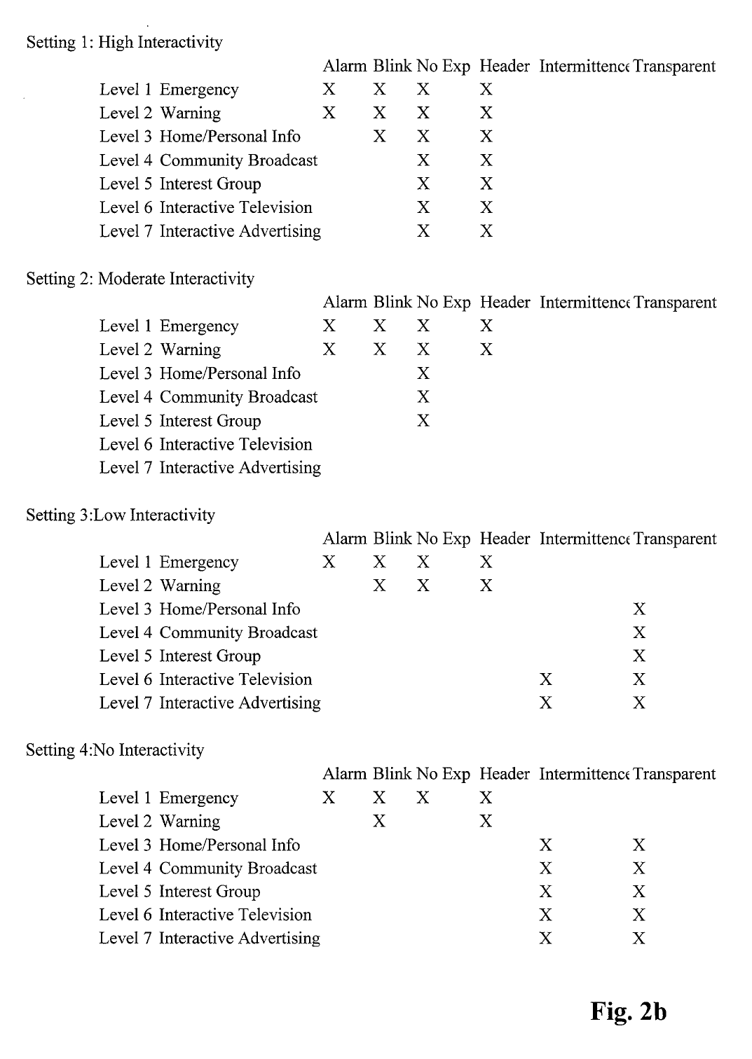

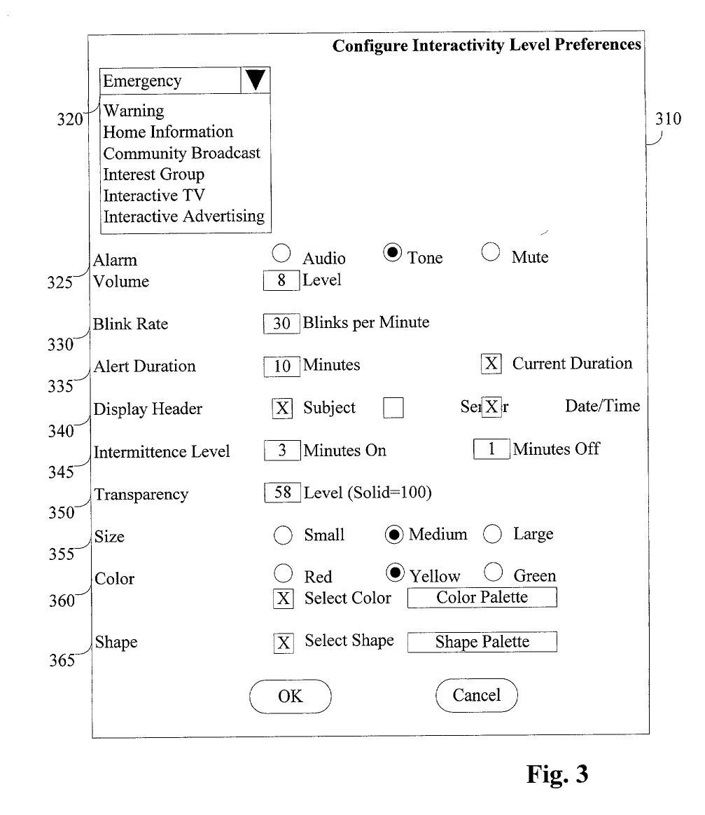

FIG. 2a illustrates a GUI 210 for selecting Smart Icon Interactivity preference levels. Levels include High Interactivity, Moderate Interactivity, Low Interactivity, No Interactivity, and Customize Interactivity. Each interactivity level has it's own set of default presets. These presets are illustrated in FIG. 2b. When a user selects customize interactivity an additional GUI is displayed as will be discussed in FIG. 3.

FIG. 2b more specifically illustrates predetermined settings for each interactivity level as discussed in FIG. 2a. A table of settings represents each aspect of a given level. Each interactivity level is represented by several notification level settings. For instance, when the icon is configured for emergency notification, there are attributes or other parameters that are adjusted to constitute a settings level for one aspect of notification. The level of notification is determined from the context of the published message. Some settings for a specific notification include Alarm, Blink, No Expire, Immediate Message Display, Intermittence, and Transparency. All settings affect how the SmartIcon is generated and displayed. For example, a security alarm message may require specific settings such as an audible alarm having no expiration or intermittence level and the display of a large size blinking opaque icon without deferred messaging. Alternatively, a community block party announcement may require specific settings such as no alarm having a short expiration and a small size transparent icon. Furthermore, the message is received by subscribers of the same PNAN with a given GNAN so as to be unobtrusive to the viewing public as possible.

FIG. 3 illustrates a GUI 310 for configuring interactivity by adjusting notification level 320 settings. A notification level 320 is selected to determine configuration parameters associated with selected notification level 320 setting. Included in the configuration parameters are an alarm parameter 325 for a user to select audio, tone, mute, and volume settings. A blink rate 330 determines how fast the SmartIcon 192 will blink. An alert duration 335 determines how long the SmartIcon 192 is displayed. A header parameter 340 determines what header information is displayed in association with the SmartIcon 192. An intermittence level 345 determines what interval for the SmartIcon 192 to intermittently persists. A transparency level 350 determines opaqueness of the SmartIcon 192. A size level 355 determines what size the SmartIcon 192 is displayed. A color level 360 determines the color of the SmartIcon 192 and a shape level 365 determines the SmartIcon 192 image/shape for display. These settings are stored in a database (not shown).

Message severity is equivalent to notification levels 320, which includes a Level 1 Emergency for tornadoes, earthquakes, Emergency Broadcast System (EBS), home security break-ins, etc. A Level 2 warning is for information that needs a subscriber's immediate attention such as school closings, broken device in home, etc. A Level 3 Home Information is used to notify a subscriber of informative tips that are not emergency related such as a home device not operating at peak efficiency or suggestions on how to improve device usage. A level 4 community broadcast informs subscribers of a block party, bake sale, street closing, etc. A level 5 Interest Group informs a PNAN of a needed fourth for golf, or recipe tip, etc. A level 6 Interactive TV notification informs a viewer about upcoming shows and how to interact with such show. A level 7 Interactive Advertising notifies a subscriber of related rebates, coupons, or purchases associated with an advertised commercial.

The implementation of icon configuration extends well beyond that of a stand alone computing device. Icon configuration in a network is scalable across different NANs and performed locally or remotely in a centralized or distributed manner. For instance in the case of emergency notification, federal, state or local authorities may be able to remotely initiate a configuration override to subscriber nodes on a network in response to natural disasters or the like illustrating that configuration is not static but rather a dynamic process with regard to physical events that affect communities and lives.

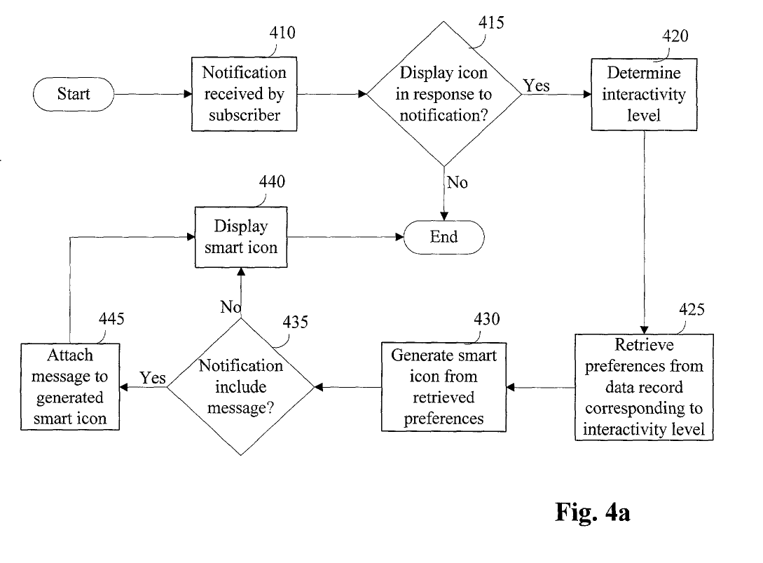

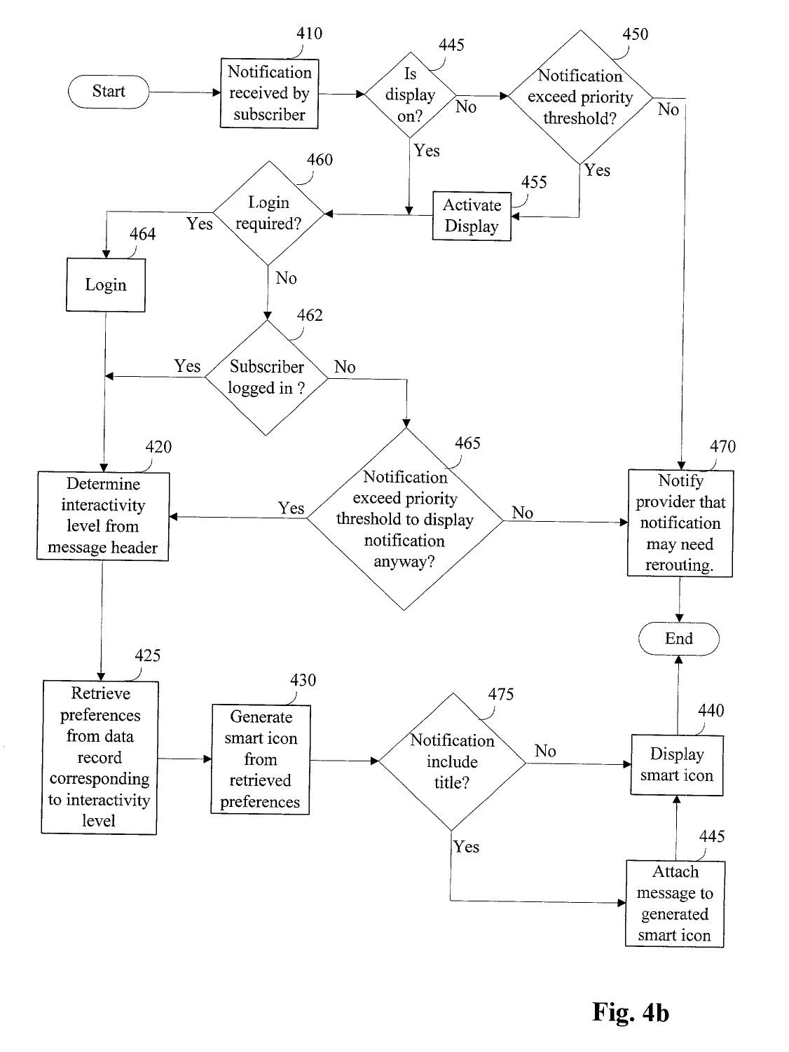

FIG. 4a illustrates the steps for receiving information for generating an icon. Notification is received at step 410 by a subscriber device and it is determined at step 415 if an icon is to be displayed in response to the received notification at step 410. When the icon at step 415 is to be displayed, the interactivity level or message severity is determined at step 420 from the context of the received notification at step 410 and preferences are retrieved at step 425 from at least one data record corresponding to interactivity level configuration settings as discussed in FIG. 3b. A SmartIcon 192 is then generated at step 430 from the retrieved preferences and it is determined at step 435 if there is a message associated with the icon from the received notification at step 410. If there is no associated message, then the SmartIcon 192 is displayed at step 440. However, when there is an associated message, the message is attached at step 445 to the generated icon at step 430 and then displayed at step 440.

FIG. 4b illustrates steps that further detail the icon generation process. Notification is received at step 410 by a subscriber device and it is determined at step 445 if the display of the device is on. If the display is not on at step 445 and it is determined at step 450 that the received notification at step 410 exceeds a predetermined threshold, then the display is activated at step 455. When the received notification at step 410 does not exceed a predetermined threshold the sender of such notification is notified at step 470 that the notification may need rerouting. When the display is either activated or on it is determined at step 460 if a login is required. If a login is not required then it is determined at step 462 if the subscriber is logged in. If the subscriber is not logged in and the notification exceeds a priority threshold at step 465 to display notification anyway or when the subscriber is logged in at step 464 then the interactivity level is determined from the message context. When the notification does not exceed the priority threshold at step 465 then the sender of such notification is notified at step 470 that the notification may need rerouting.

After the interactivity level is determined at step 420, preferences are retrieved at step 425 from at least one data record corresponding to interactivity level configuration settings. A SmartIcon 192 is then generated at step 430 from the retrieved preferences and it is determined at step 435 if the received notification at step 410 includes title information at step 475 to be attached to the icon. If there is no associated title information at step 475 then the SmartIcon 192 is displayed at step 440. However, when there is an associated title at step 475, the title is attached at step 445 to the generated icon at step 430 and then displayed at step 440.

For example, a tornado warning may turn on a television set that is not powered on. A home security alert may override any users that are logged in. However, the notification of a bake sale will not turn on a television or override another user but may be rerouted for reception to another device. Furthermore, different status alerts may be displayed depending on whether a user and/or a specific user is logged in or not. For instance, the John Doe residence uses a LAS where Jane Doe subscribes to community events related to homemaking. When the notification of a bake sale is published to the NNS from a member of the community, while Jane Doe is logged into the LAS, an icon is dynamically configured to display a yellow alert because Jane has subscribed to such a. published event. However, if no one is logged in to the LAS or another family member was logged in at the time of the published notification, an icon is dynamically configured to display a green alert indicating a general message related to other users of the LAS.

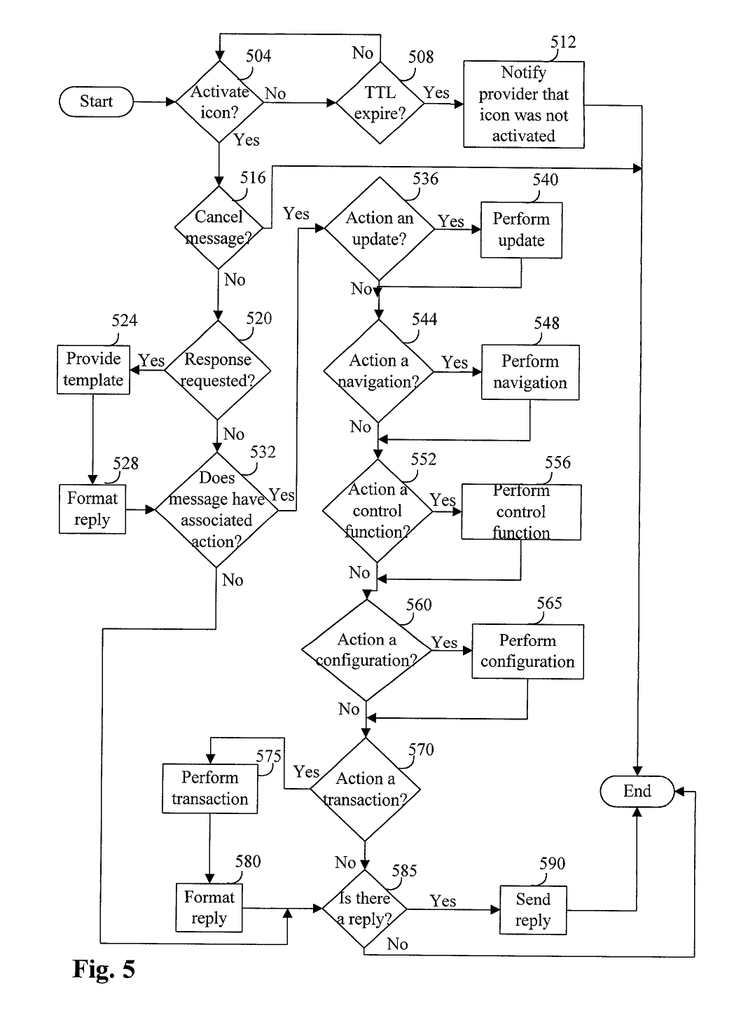

FIG. 5 illustrates the steps for activating an icon upon display. If a generated displayed icon is not activated at step 504, then it is determined at step 508 if the icon has expired. When the icon expires at step 508, the icon is no longer displayed and the sender at step 512 of the icon is notified that the recipient icon has expired. When the icon is activated before the icon expires, it is determined if the activation is a cancelled action at step 516. If the activation is other than a cancelled action at step 516, it is then determined if a response is requested at step 520 from the displayed icon. When a response is requested at step 520 a template at step 524 is displayed and a reply is formatted at step 528 based on submitting the completed template. After a reply is formatted at step 528 or when a response is not requested at step 520, it is determined at step 532 if the message from the icon has an associated action.

If there is an associated action at step 532, then it is determined at step 536 if the action is an update. When the action is an update, an update action is performed at step 540. If not, then it is determined at step 544 if the action is a navigation procedure. When the action is a navigation procedure at step 544, navigation is performed at step 548. If not, then it is determined at step 552 if the action is a control function. When the action is a control function, a control function is performed at step 556. If not, then it is determined at step 560 if the action is a configuration. When the action is a configuration, a configuration procedure is performed at step 565. If not, then it is determined at step 570 if the action is a transaction. When the action is a transaction, a transaction is performed at step 575 and a reply is formatted at step 580. After a reply is formatted (528, 580) or when the action is not a transaction at step 570, it is determined at step 585 if a reply is needed. When it is determined a reply is needed then a reply is sent at step 590.

For example, a message requesting a fourth person for golf is sent to a set of subscribers. A SmartIcon triggers a template to allow a formatted reply to the invitation/message. For those subscribers that choose not to respond to the message, the icon carries an expiration and removes the message once it expires. Alternatively, once a fourth person for golf is found, a follow-up message to the SmartIcon is sent canceling, the original invitation to those who have not reviewed it yet so as to eliminate redundant or unneeded messaging.

An example of an update action is when the utility company changes the price of kilowatt-hours, which may affect what operations, or the order of operations performed in the home. The updated pricing is stored in the system and operations if any are changed accordingly. An example of a navigation action is when an alert regarding a malfunction is sent from the HVAC system, the HVAC GUI portion of the interface is displayed to correct for such an alert or a URL of a preferred local HVAC vendor who can repair the alert is retrieved and a network connection established to access the URL. An example of a control action is automatically changing the setting of an alarm clock to earlier or later based on new information received such as school closings or delays in departure of a flight. An example of a configuration action is a suggestion message related to the use of a security system. For instance, the automatic dimming of the foyer lights in response to setting the security alarm is based on predictive analysis and behavioral trending by learning from subscriber usage patterns over time. Usage patterns are modeled from event logging of published events maintained in the LAS or NNS. An example of a transaction is to automatically schedule a visit from a vendor to repair the HVAC in response to any of the actions listed above.

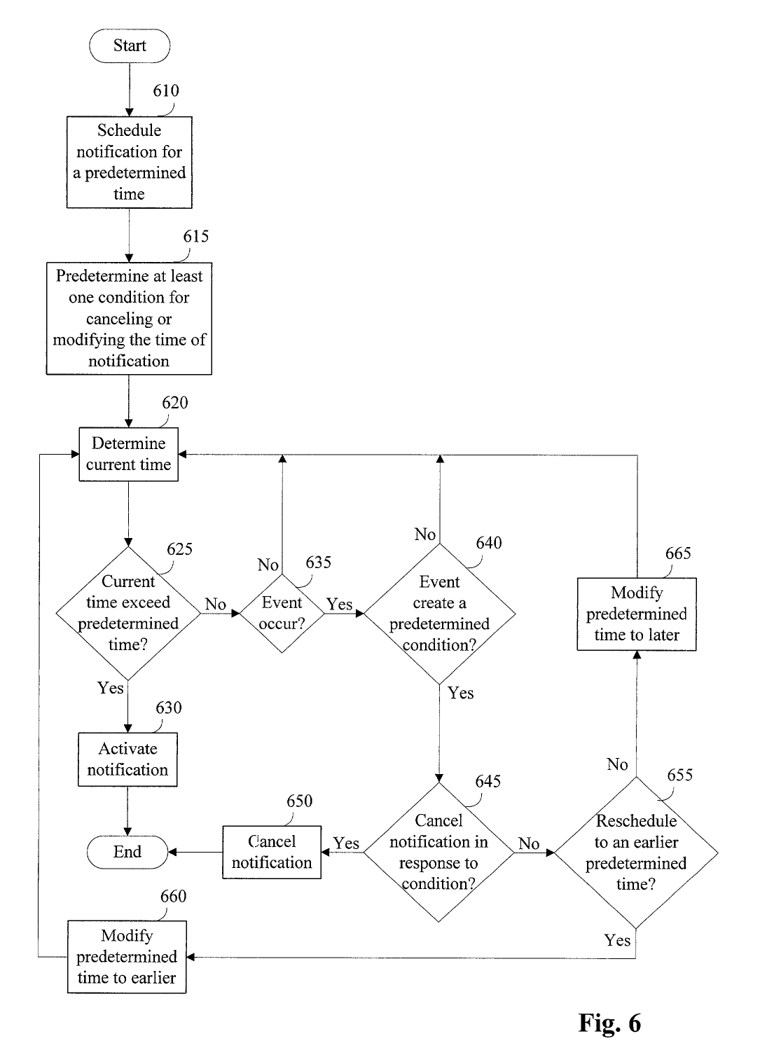

FIG. 6 illustrates the steps for modifying a scheduled notification based on a created condition in response to events. A device is scheduled at step 610 to notify a user at a predetermined time. In addition, at least one condition is predetermined at step 615 for canceling or modifying the time of notification. According to one aspect of the present invention, the notification is a wake up call and the condition is created by applying rules with regard to the transpiration of events (e.g., school closings, stock quotes, delays in scheduled travel, etc.) before the scheduled notification time at step 610. A user who is asleep has no awareness of such events that may occur which may affect the outcome of when the user is to be awakened. After determining both the scheduled notification time and the conditions at step 615 for modification of such notification time, the current time is then determined at step 620. When the current time exceeds the predetermined notification time at step 625, notification is activated at step 630.

Notification can be operatively performed by substantially any means such as email, telephone, pager, alarm clock, activation of any audio/visual device, or the like. If the current time has not exceeded the predetermined time at step 625 and an event has not occurred at step 635, then steps (620, 625, 635) are repeated until an event does occur or notification is activated. When an event occurs, it is determined at step 640 if a condition is created in response to the event. If no condition is repeated, then steps (620, 625, 635) are repeated. When a condition is created, it is determined at step 645 if notification is cancelled in response to the condition. If so, then notification is cancelled at step 650. If not, then it is further determined at step 655 if notification is to be rescheduled to an earlier time. If so, then an earlier time is rescheduled. If not, then a later time is rescheduled. In either case steps (620, 625, 635) are repeated until notification is either activated at step 630 or cancelled at step 650.

Although the invention has been shown and described with respect to a certain aspect or aspects, it is obvious that equivalent alterations and modifications will occur to others skilled in the art upon the reading and understanding of this specification and the annexed drawings. In particular regard to the various functions performed by the above described integers (components, assemblies, devices, compositions, etc.), the terms (including a reference to a “means”) used to describe such integers are intended to correspond, unless otherwise indicated, to any integer which performs the specified function of the described integer (i.e., that is functionally equivalent), even though not structurally equivalent to the disclosed structure which performs the function in the herein illustrated exemplary aspect or aspects of the invention. In addition, while a particular feature of the invention may have been described above with respect to only one of several illustrated aspects, such feature may be combined with one or more other features of the other aspects, as may be desired and advantageous for any given or particular application.

The description herein with reference to the figures will be understood to describe the present invention in sufficient detail to enable one skilled in the art to utilize the present invention in a variety of applications and devices. It will be readily apparent that various changes and modifications could be made therein without departing from the spirit and scope of the invention as defined in the following claims.

What is claimed is:

1. A configurable messaging system, comprising:
an icon providing a message to a user, wherein the icon is configurable to provide the message based upon an interactivity level.

2. The system of claim 1, wherein the interactivity level is based upon predetermined settings.

3. The system of claim 2, wherein the predetermined settings define event thresholds to trigger the message being provided to the user.

4. The system of claim 3, wherein the event thresholds are defined by at least one of high, moderate, low, custom, and no interactivity.

5. The system of claim 4, wherein the at least one of high, moderate, low, custom, and no interactivity may be defined by notification levels.

6. The system of claim 5, wherein the notification levels are configured according to at least one of emergency, warning, home, community, interest group, interactive television, and interactive advertising.

7. The system of claim 4, wherein the notification levels are determined from the context of the message.

8. The system of claim 6, wherein the icon generation and display changes based upon the notification levels.

9. An icon for use in a graphical user interface, comprising:
a software object which allows for a user to configure the icon with respect to at least one of the following parameters: volume; blink rate; alert duration; display header; intermittence level; transparency; size; color and shape.

10. The graphical user interface of claim 9, wherein the volume may be adjusted per audio level, tone and mute.

11. The graphical user interface of claim 9, wherein the intermittence level may be adjusted for at least one of time off and time on.

12. The graphical user interface of claim 9, further comprising at least one of advertising space, a browser space, and status icons.

13. A method providing configurable messaging, comprising:
sending a message to a user; and
configuring an icon to receive the message based upon an interactivity level.

14. The method of claim 13, wherein the interactivity level is based upon predetermined settings.

15. The method of claim 13, further comprising,
defining event thresholds to trigger the message being provided to the user.

16. The method of claim 15, wherein the event thresholds are defined by at least one of high, moderate, low, custom, and no interactivity.

17. The method of claim 16, wherein the at least one of high, moderate, low, custom, and no interactivity may be defined by notification levels.

18. The method of claim 17, wherein the notification levels are configured according to at least one of emergency, warning, home, community, interest group, interactive television, and interactive advertising.

19. The method of claim 16, wherein the notification levels are determined from the context of the message.

20. The method of claim 18, further comprising,
changing the icon based upon the notification levels.

21. A system providing configurable messaging, comprising:
means for sending a message to a user; and
means for configuring an icon to receive the message based upon an interactivity level.

22. The system of claim 21, wherein the interactivity level is based upon predetermined settings.

23. The system of claim 23, wherein the predetermined settings define event thresholds to trigger the message sent to the user.

24. A computer system for providing information to a user, comprising:
a first computer operatively coupled to a second computer, the first computer providing the second computer with information to be accessed by a user of the second computer, the second computer including a graphical user interface to facilitate the user accessing the information; and
an icon providing the information to the user, wherein the icon is configurable to provide the information based upon an interactivity level.

25. A computer system for providing information to a user, comprising:
a first computer operatively coupled to a second computer, the first computer providing the second computer with information to be accessed by a user of the second computer, the second computer including a graphical user interface to facilitate the user accessing the information;
an icon for use with the graphical user interface, the icon allowing the user to configure the icon with respect to at least three of the following parameters: volume; blink rate; alert duration; display header; intermittence level; transparency; size; color and shape;
wherein the parameters vary as a function of the user configuration and the content of the information.
